(19) United States
(12) Patent Application Publication
(10) Pub. No.: US 2007/0130819 A1
(43) Pub. Date: Jun. 14, 2007

(54) Apparatus for trapping pests

(76) Inventors: Amram Ohayon, Beer Sheva (IL); Michel Cohen, Omer (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/297,110

(22) Filed: Dec. 8, 2005

(51) Int. Cl. A01M 23/08

(52) U.S. Cl. 43/66; 43/65

(57) ABSTRACT

An apparatus for trapping pests is disclosed including a housing defining an internal chamber with a floor in which an entrapped pest remains until being released from the chamber, an inclined, tubular passageway spaced above the floor of said chamber that is closed at a first end and open at a second end, a space for receiving bait placed underneath the passageway, an aperture formed in the wall of the passageway and in communication with the internal chamber, and an occluding element that is insertable and displaceable within the passageway. The occluding element is upwardly displaceable upon ingress of a pest within the passageway by pressure exerted by the pest and downwardly displaceable by gravity upon passage of the pest through the aperture formed in the wall of the passageway, so that the pest is trapped within the chamber following displacement of the element below the aperture.

### FIELD OF THE INVENTION

The present invention relates to the field of animal traps. More particularly, the invention relates to an apparatus suitable for trapping a variety of pests, without use of any working parts.

### BACKGROUND OF THE INVENTION

The prior art is replete with numerous types of traps for trapping and killing crawling pests, such as mice and insects. Many include a sticky surface, to which the pest adheres when it is attracted by bait placed in close proximity to the sticky surface. Besides causing suffering to a pest after being trapped, the trap is usually quite unsightly due to the large number of insects that may be trapped thereby, or due to the sight of a mouse and droppings that may also adhere to the sticky surface, and therefore those of a weak disposition prefer not to dispose the trapped pests.

Other traps are provided with a gate responsive to the entry of an animal, such that the animal is prevented from escaping from the trap upon closure of the trap. For example, U.S. Pat. No. 5,386,663 teaches an animal trap comprising an entrance to an internal chamber having an opening allowing access to a passageway with a lower surface spaced above the floor and a gate pivotably mounted in the passageway which is normally closed within the passageway, whereby an animal may enter the passageway, open the gate, pass therethrough and fall into the chamber while the gate closes to prevent the escape of the animal. These traps comprise moving parts that enable the gate to assume a closed position, and over the course of time, due to the infiltration of dirt or dust, for example, or due to rust, the gate may not completely close, and the entrapped animal is liable to escape. Also, a limb of the entrapped animal is liable to be hurt by the rapid closure of the gate.

It is an object of the present invention to provide an animal trap that has no moving parts.

It is an additional object of the present invention to provide an animal trap that reliably traps an animal.

It is an additional object of the present invention to provide an animal trap that does not cause suffering to an entrapped animal.

Other objects and advantages of the invention will become apparent as the description proceeds.

### SUMMARY OF THE INVENTION

The present invention provides an apparatus for trapping pests including a housing defining an internal chamber with a floor in which an entrapped pest remains until being released from said chamber; at least one tubular passageway spaced above the floor of said chamber, each of said passageways being closed at a first end and open at a second end, and being inclined so that said first end is higher than said second end; a space for receiving bait placed underneath said at least one tubular passageway; an aperture formed in the wall of each passageway and in communication with said internal chamber; and an occluding element which is insertable and displaceable within each of said passageways, wherein each occluding element is upwardly displaceable upon ingress of a pest within the corresponding passageway by pressure exerted by said pest and downwardly displaceable by gravity upon passage of said pest through said aperture formed in the wall of said passageway, said pest being trapped within said chamber following displacement of said element below said aperture.

In a preferred embodiment of the invention, the occluding element is spherical, the outer diameter of each element being substantially equal to, and less than, the inner diameter of a corresponding passageway.

Each occluding element preferably is made of a rigid and smooth outer surface. The trapped pest is not capable of escaping from the housing by drawing the occluding element towards the closed end of a passageway, due to the smoothness of the outer surface of an element. An occluding element is preferably made from polypropylene, or any other suitable polymer, and may be solid or hollow. An exemplary occluding element is a ping-pong ball.

Each occluding element is retained in a corresponding passageway. In order to prevent the discharge of an occluding element from the corresponding passageway, each occluding element is sized such that its outer diameter is greater than the width of the open end of a passageway, or alternatively, the inner wall of a passageway is provided with an abutment, in order to limit the downward displacement of an occluding element.

In one preferred embodiment of the invention, each passageway is made from wire netting. The wire netting applies a reactive force to the legs of a pest that has entered a passageway, thereby providing the pest with greater stability. The required force applied by the pest in order to upwardly displace the occluding element is therefore reduced, resulting in a greater number of pests that can upwardly displace said element and be trapped after entering the chamber via the aperture. Furthermore, the wire netting allows dirt and sand which may cling to the body of a pest to fall to the floor of the internal chamber. Without provision of the wire netting, the dirt and sand is liable to accumulate within a passageway and prevent the occluding element from rolling downwards, after being upwardly displaced, due to the increased frictional force.

Preferably-the distance between the closed end of a passageway and the corresponding aperture is considerably less than the distance between the closed end and the open end thereof; the open end of each passageway is contiguous with a wall of the housing; each passageway is formed with scent permeating holes; the space for receiving bait is a perforated enclosure having an inclined cover, the inclination of said cover being substantially equal to the inclination of each passageway; the perforated enclosure is removable from the housing; the perforated enclosure is integrally formed with a tray on which pest droppings are collected; the housing is formed with a closable opening, through which the entrapped pest may be released and the perforated enclosure may be removed.

Pests that may be trapped by the apparatus are selected from the group of rodents, such as mice, rats and squirrels, snakes, cats, and insects such as cockroaches, ants, scorpions and the like. Each passageway is suitably sized to allow for the passage therethrough, and the subsequent entrapment, of a pest. When a plurality of passageways. are employed, more than one pest may be trapped by a corresponding occluding element at a given time and retained within the internal chamber, before being released from the housing via the closable opening.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an apparatus for trapping pests, according to an embodiment of the invention;

FIGS. 2A-G are schematic drawings of a passageway in which an occluding element is displaceable, depicting successive stages by which a pest is trapped by use of the invention;

FIGS. 3 and 4 are schematic drawings in side view of an apparatus for trapping pests, showing the coexistence of multiple pests within a chamber in which they are confined; and

FIG. 5 is a perspective view of a passageway, according to another embodiment of the invention.

### DETAILED DESCRIPTION OF PREFERRED EMBODIMENTS

The present invention is a novel trap that has no moving parts for confining pests in a housing within which they are free to move about, without causing pain or suffering to the pests, whereupon they may released into a natural habitat, such as a forest, transferred to a zoo, or be destroyed. A pest is trapped by means of a gravity-actuated occluding element that is freely displaced within an inclined passageway upon passage therethrough of the pest.

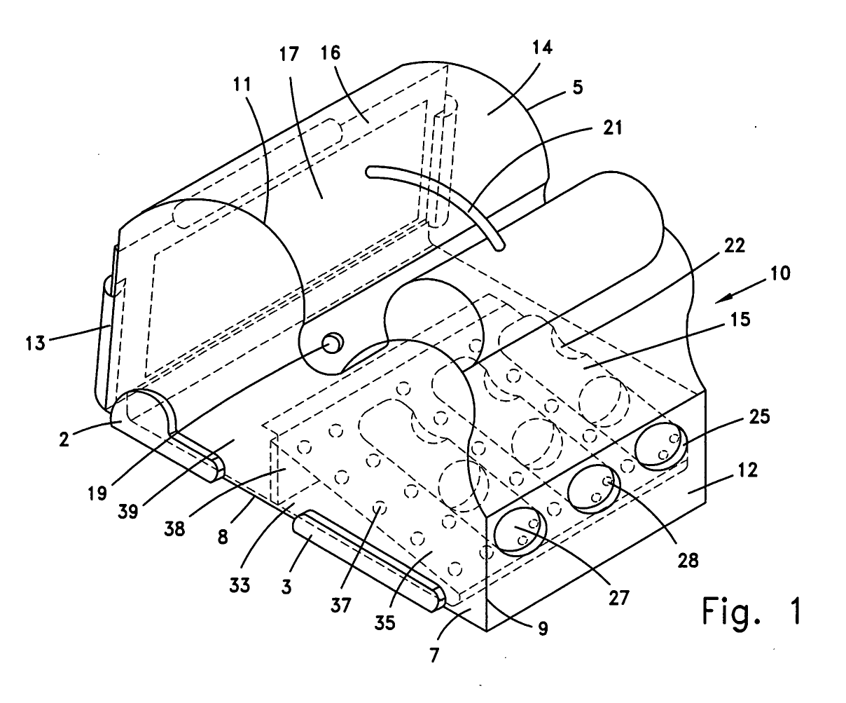

Referring now to FIG. 1, one preferred embodiment of the inventive trap, generally designated as 10, is shown. Trap 10 comprises housing 5, a plurality of inclined passageways 15 and a gravity-actuated occluding element 25 insertable into a corresponding passageway 15. Housing 5, which is stabilized by support members 2 and 3, is provided with a pair of sidewalls 7 having a flat bottom 8 and sides 9 and a multi-curved upper edge 11, front wall 12 extending between, and parallel to, the two opposing sidewalls 7, curved covering 14, the shape of which is compatible with the contour of upper edge 11, and removable rear portion 16, which is configured to close, and prevent escape from, opening 17, all of which define an internal chamber in which an entrapped pest is free to move about until being released therefrom. Rear portion 16 is slidable within suitably shaped grooves 13. Covering 14 is formed with apertures 19, to allow for the circulation of air within the chamber. Housing 5 is preferably produced from injected molding to allow for cost-effective manufacturing, and may be made from transparent plastic, so that an entrapped pest may be readily visible, or alternatively, from an opaque material for those users having a weak constitution. Handle 21 connected to covering 14 facilitates transportation of the housing.

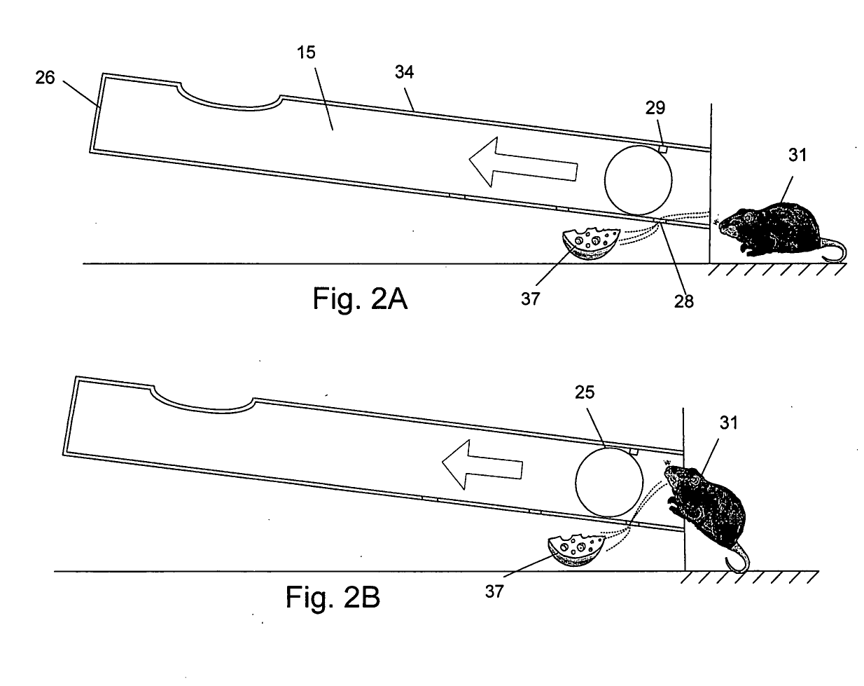

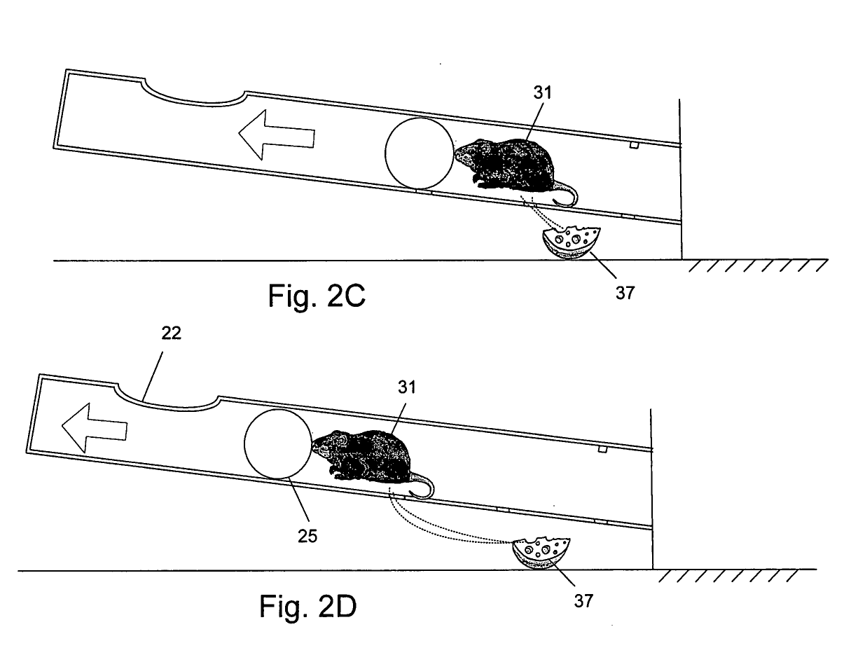

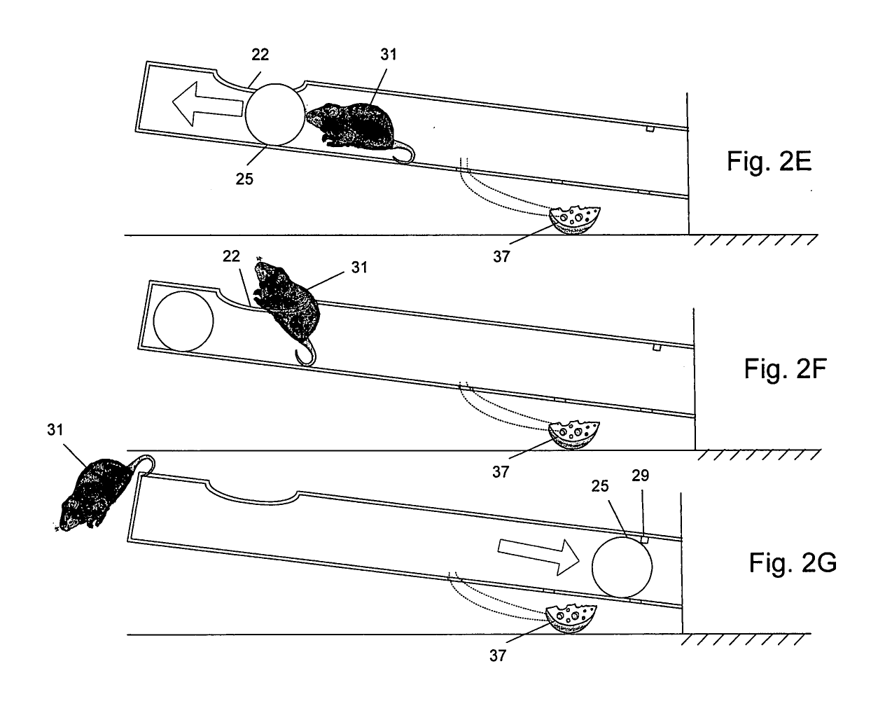

Each passageway 15 is tubular, and is formed with a closed end 26 and an open end 27 (FIG. 2A). Open end 27 of each passageway 15 is connected to front wall 12 in such a way that the passageway is inclined with respect to bottom 8 of housing 5, with the open end being spaced above bottom 8 and the closed end being higher than the open end. Aperture 22 is formed in the upper surface of each passageway, at an intermediate location between closed end 26 and open end 27, and preferably relatively close to closed end 26, as will be explained hereinafter, and is in communication with the internal chamber.

Spherical occluding element 25 is insertable within each passageway 15, and the outer diameter of each element is substantially equal to, and less than, the inner diameter of a corresponding passageway. As a result, a pest entering a passageway cannot squeeze between element 25 and wall 34 of the passageway. After element 25 is inserted within a passageway, abutment 29 (FIG. 2A) is affixed to the inner surface of wall 34, to thereby limit the downward displacement of element 25 and to prevent the discharge thereof from the passageway. Abutment 29 is positioned on a suitable location along wall 34, in order to ensure that at least one scent permeating hole 28 formed in the bottom of the passageway inner surface will not be covered by element 25. Occluding element 25 may be made from any suitable material having a relatively low coefficient of friction, and is preferably made from polypropylene, or any other suitable polymer that is rigid and smooth. Element 25 may be solid or hollow. An exemplary occluding element is a ping-pong ball.

Bait for attracting a pest is placed within wedge-shaped receptacle 33 having a perforated cover 35 and a slidable rear portion 38. The width of receptacle 33 is slightly less than rear opening 17, to allow the receptacle to be removable from the housing so that the bait may be replaced. Bait may remain within receptacle 33 for an extended period of time since the bait is inaccessible to pests confined within housing 5. The spacing between rear portion 38 of the receptacle and cover 35 is significantly less than the body width of a pest confined within the housing. The interior of receptacle 33 is accessible to a user by upwardly sliding rear portion 38 within suitably shaped grooves.

Receptacle 33 is structured such that the inclination of cover 35 is substantially equal to the inclination of passageways 15, so that perforations 37 of cover 35 will be in close proximity to scent permeating holes 28 of the passageway. A pest entering a passageway 15 will therefore smell the scent permeating through holes 28 and will upwardly push element 25 while searching for the source of the scent.

Receptacle 33 may be integrally formed with a tray 39, in order to facilitate release of a confined pest, or insertion and removal of the receptacle. Furthermore, pest droppings are collected on tray 39, and cleaning of housing 5 is simplified by use of tray 39.

It will be appreciated that bait need not be placed in a receptacle, but rather may be placed in an open space underneath at least one of the passageways, as illustrated in FIGS. 2-4.

The following description relates to the confinement of mice, but this should be considered as a non-limitative example, since the trap is suitable for the confinement of other types of pests as well, such as rodents, snakes and insects.

The efficacy of the present invention in terms of trapping mice is illustrated in FIGS. 2A-G. Mouse 31 approaches open end 27 of passageway 15 in FIG. 2A after smelling the scent of bait 37 through scent permeating holes 28 and jumps into the passageway in FIG. 2B. In FIG. 2C, mouse 31 searches for bait 37 and begins to push occluding element 25 upwards. Element 25 is further pushed by the mouse in FIG. 2D and approached aperture 22. As element 25 is additionally pushed in FIG. 2E, mouse 31 sees aperture 22 and thinks that bait 37 can be found by traversing the aperture. Mouse 31 traverses aperture 22 in FIG. 2F and jumps into the chamber in FIG. 2G, while element 25 rolls downwards until contacting abutment 29, thereby trapping the mouse and confining it to the internal chamber.

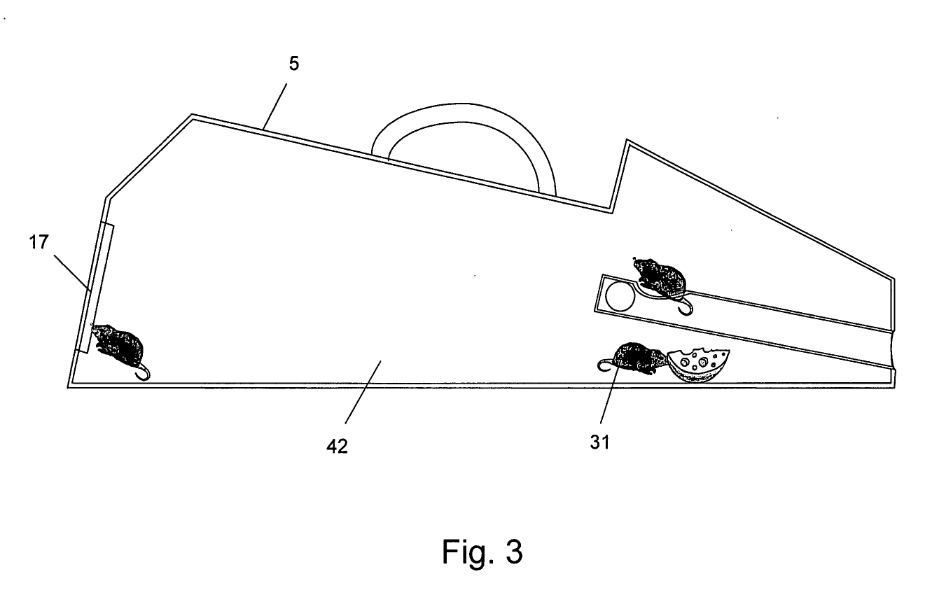

As shown in FIG. 3, more than one mouse 31 may be trapped by housing 5 at a given time and confined within internal chamber 42. Each mouse may enter chamber 42 simultaneously via different passageways or successively via the same passageway, or via multiple passageways. The mice may live in coexistence within the chamber, due to the relatively large area enclosed by the housing, within which the mice can walk around and eat. After a period of time, mice 31 are released from the housing via closable opening 17 and chamber 42 may be cleaned.

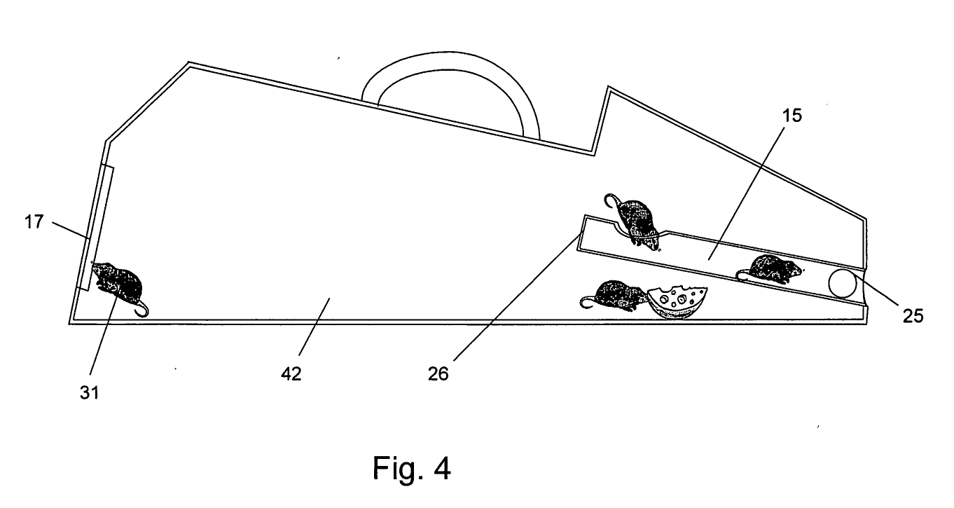

When being confined within chamber 42, mice 31 seek different ways of escape therefrom, as shown in FIG. 4. Since opening 17 is closed, rearward escape is precluded. Similarly, escape through passageway 15 is also precluded, due to the presence of occluding element 25. The trapped mice are not capable of drawing occluding element 25 towards closed end 26 of the passageway, due to the smoothness of element 25. Studies conducted by the applicant indicated that mice indeed attempted to draw the occluding element upwards, but were unsuccessful to do so. The studies further revealed that the mice were not intelligent enough to collaborate, that is a mouse standing on top of passageway 15 did not jump into the passageway during that instance that element 25 was displaced upwardly of aperture 22, as shown in FIG. 2F, which would have afforded that mouse freedom. By forming aperture 22 at a position proximate to closed end 26, the chances of escape are further reduced, since occluding element 25 downwardly rolls within a split second, before a mouse realizes that escape is possible.

It was found that the illustrated configuration of the trap was successful in confining a variety of pests, including cats, snakes and cockroaches. The dimensions of the passageways and chamber were changed, relative to the size of the pest which was intended to be captured. The trapped pests were not harmed in any way, and were able to be released to their natural habitat.

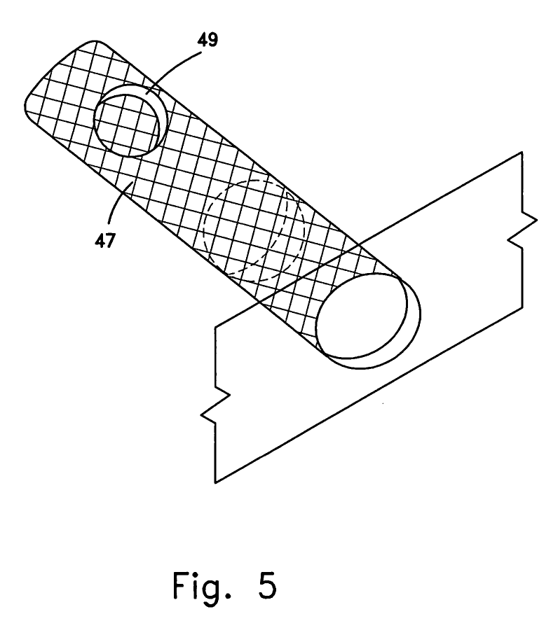

FIG. 5 illustrates another embodiment of the invention wherein each passageway 47 is made from wire netting. Some smaller pests such as ants may slip on a smooth passageway and therefore may not have the needed stability to displace the occluding element. The wire netting applies a reactive force to the legs of a pest that has entered a passageway. The required force applied by the pest in order to upwardly displace the occluding element is therefore reduced, resulting in a greater number of pests that can upwardly displace the element and be trapped after entering the chamber via aperture 49. In order to provide optimal stability to pests entering a passageway, the mesh count, or the number of metal wires per linear inch, is predetermined, depending on the size of the intended pest to be confined.

By employing wire netting, dirt and sand clinging to the body of a pest may fall through the open space between parallel wires to the floor of the internal chamber. Without use of wire netting, the dirt and sand is liable to accumulate within a passageway and prevent the occluding element from rolling downwards, after being upwardly displaced, due the sand and/or dirt which would be interspersed between the occluding element and the wall of the passageway and cause an increase in the frictional force applied to the element.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. An apparatus for trapping pests comprising:
a housing defining an internal chamber with a floor in which an entrapped pest remains until being released from said chamber;
at least one tubular passageway spaced above the floor of said chamber, said at least one tubular passageway being closed at a first end and open at a second end, and being inclined so that said first end is higher than said second end;
a space for receiving bait placed underneath said at least one tubular passageway;
an aperture formed in the wall of said at least one tubular passageway and in communication with said internal chamber; and
an occluding element which is insertable and displaceable within each of said at least one tubular passageway,
wherein each occluding element is upwardly displaceable upon ingress of a pest within said at least one tubular passageway by pressure exerted by said pest and downwardly displaceable by gravity upon passage of said pest through said aperture formed in the wall of said at least one tubular passageway, said pest being trapped within said chamber following displacement of said element below said aperture.

2. The apparatus according to claim 1, wherein the occluding element is spherical, the outer diameter of each element being substantially equal to, and less than, the inner diameter of said at least one tubular passageway.

3. The apparatus according to claim 1, wherein each occluding element is made of a rigid and smooth outer surface.

4. The apparatus according to claim 3, wherein the occluding element is made from polypropylene or any other suitable polymer.

5. The apparatus according to claim 1, wherein the occluding element is solid or hollow.

6. The apparatus according to claim 1, wherein the outer diameter of the occluding element is greater than the width of the open end of said at least one tubular passageway.

7. The apparatus according to claim 1, wherein the inner surface of a passageway wall is provided with an abutment, in order to limit the downward displacement of an occluding element.

8. The apparatus according to claim 1, wherein said at least one tubular passageway is made from wire netting.

9. The apparatus according to claim 1, wherein the distance between the closed end of said at least one tubular passageway and the aperture is considerably less than the distance between the closed end and the open end thereof.

10. The apparatus according to claim 1, wherein the open end o0 said at least one tubular passageway is contiguous with a wall of the housing.

11. The apparatus according to claim 1, wherein said at least one tubular passageway is formed with scent permeating holes.

12. The apparatus according to claim 11, wherein the space for receiving bait is a perforated enclosure having an inclined cover, the inclination of said cover being substaintially equal to the inclination of each passageway.

13. The apparatus according to claim 12, wherein the perforated enclosure is removable from the housing.

14. The apparatus according to claim 13, wherein the perforated enclosure is integrally formed with a tray on which pest droppings are collected.

15. The apparatus according to claim 13, wherein the housing is formed with a closable opening, through which the entrapped pest is released and/or the perforated enclosure is removed.

16. The apparatus according to claim 1, wherein pests that are trappable by the apparatus are selected from, but not limited by, the group of rodents, including mice, rats and squirrels, snakes, cats, and insects, including cockroaches, ants, scorpions and the like.

17. The apparatus according to claim 16, wherein said at least one tubular passageway is suitably sized to allow for the passage therethrough, and the subsequent entrapment, of a predetermined pest.

18. The apparatus according to claim 1, wherein more than one pest is confinable within the internal chamber, before being released from the housing via the closable opening.
